(19) United States
(12) Patent Application Publication
(10) Pub. No.: US 2021/0024066 A1
(43) Pub. Date: Jan. 28, 2021

(54) PERSONALIZED CRUISE SPEED SUGGESTION TO IMPROVE TRAFFIC FLOW

(71) Applicant: GM Global Technology Operations LLC, Detroit, MI (US)

(72) Inventors: Sharon Hornstein, Pardes Hanna (IL); Claudia V. Goldman-Shenhar, Mevasseret Zion (IL)

(21) Appl. No.: 16/520,049

(22) Filed: Jul. 23, 2019

(51) Int. Cl. B60W 30/14; B60W 50/08

(52) U.S. Cl. CPC B60W 30/143; B60W 50/085

(57) ABSTRACT

A system and method obtain a cruise speed for a vehicle. The method includes computing an optimal speed for the vehicle in consideration of traffic flow, the computing the optimal speed being based on the cruise speed and additional information. The method also includes determining a personalized speed for the vehicle based on a model corresponding with a current user of the vehicle, and suggesting the personalized speed to the current user for a response. A new cruise speed for the vehicle is set according to the response of the current user. The vehicle is controlled to travel at the new cruise speed.

### INTRODUCTION

The subject disclosure relates to a personalized cruise speed suggestion to improve traffic flow.

Vehicles (e.g., automobiles, trucks, construction equipment, farm equipment, automated factory equipment) increasingly include automation of some or all aspects of operation. In a semi-automated vehicle, for example, collision avoidance, automatic braking, and adaptive cruise control are some of the operations that are performed with minimal or no input from a driver. Conventional adaptive cruise control involves the driver setting a desired cruise speed for the vehicle. This speed is maintained automatically unless an obstacle (e.g., another vehicle that is traveling more slowly) detected in the path of the vehicle requires a temporary reduction in that speed. Speeds set manually by human drivers (such as in conventional cruise control systems) or speeds set by automated or autonomous vehicles (when no global information regarding traffic is considered) may differ from speeds optimized to improve traffic flow. When each vehicle sets its own speed in an uncoordinated manner, no optimal traffic flow can be guaranteed. Accordingly, it is desirable to provide a personalized cruise speed suggestion to improve the traffic flow.

### SUMMARY

In one exemplary embodiment, a method includes obtaining a cruise speed for a vehicle, and computing an optimal speed for the vehicle in consideration of traffic flow. The computing the optimal speed is based on the cruise speed and additional information. The method also includes determining a personalized speed for the vehicle based on a model corresponding with a current user of the vehicle, and suggesting the personalized speed to the current user for a response. A new cruise speed for the vehicle is set according to the response of the current user. The vehicle is controlled to travel at the new cruise speed.

In addition to one or more of the features described herein, the obtaining the cruise speed includes obtaining a cruise control speed setting by the current user who is a driver or using a user profile corresponding with the current user.

In addition to one or more of the features described herein, the computing the optimal speed includes determining an average speed of every other vehicle within a specified distance of the vehicle or determining a weighted average speed with weighting being higher or lower for closer other vehicles.

In addition to one or more of the features described herein, the computing the optimal speed includes determining an acceleration or deceleration required to achieve a specified speed over a specified duration.

In addition to one or more of the features described herein, the determining the personalized speed includes using a probabilistic model based on past responses by the current user or a machine learning algorithm to predict the personalized speed that maximizes acceptance by the current user.

In addition to one or more of the features described herein, the method also includes obtaining the additional information from one or more sensors, the one or more sensors including at least a radar system, a lidar system, or a camera.

In addition to one or more of the features described herein, the method also includes obtaining the additional information from another vehicle based on vehicle-to-vehicle communication.

In addition to one or more of the features described herein, the obtaining the additional information from the other vehicles includes obtaining an indication that one or more vehicles ahead of the vehicle braked, or that a distance between the other vehicles ahead of the vehicle has decreased to a threshold distance.

In addition to one or more of the features described herein, the method also includes obtaining the response from the current user. The response is a confirmation and the setting the new cruise speed includes setting the new cruise speed to be the personalized speed, or the response is an edit of the personalized speed, wherein the setting the new cruise speed includes setting the new cruise speed to be a result of the edit of the personalized speed.

In addition to one or more of the features described herein, the method also includes obtaining the response as a non-responsive period for a specified duration. The setting the new cruise speed includes setting the new cruise speed to remain the cruise speed.

In another exemplary embodiment, a system includes one or more sensors. The one or more sensors includes a radar system, a lidar system, or a camera. The system also includes a processor to obtain a cruise speed for a vehicle, to compute an optimal speed for the vehicle in consideration of traffic flow based on the cruise speed, information from the one or more sensors, and additional information, to determine a personalized speed for the vehicle based on a model corresponding with a current user of the vehicle, to suggest the personalized speed to the current user for a response, and to set a new cruise speed for the vehicle according to the response of the current user. The vehicle is controlled to travel at the new cruise speed.

In addition to one or more of the features described herein, the cruise speed is a cruise control speed setting by the current user who is a driver, a speed determined from a user profile corresponding with the current user, or from an automated decision making agent controlling a speed of an autonomous vehicle.

In addition to one or more of the features described herein, the processor computes the optimal speed by determining an average speed of every other vehicle within a specified distance of the vehicle or determining a weighted average speed with weighting being higher or lower for closer other vehicles.

In addition to one or more of the features described herein, the processor computes the optimal speed based on an acceleration or deceleration required to achieve a specified speed over a specified duration.

In addition to one or more of the features described herein, the processor determines the personalized speed by using a probabilistic model based on past responses by the current user or a machine learning algorithm that learns to predict the personalized speed that maximizes acceptance by the current user.

In addition to one or more of the features described herein, the additional information is communicated from another vehicle based on vehicle-to-vehicle communication.

In addition to one or more of the features described herein, the additional information from the other vehicles includes an indication that one or more vehicles ahead of the vehicle braked, or that the distance between the vehicles ahead has decreased to a certain threshold distance.

In addition to one or more of the features described herein, the response is a confirmation and the processor sets the new cruise speed to be the personalized speed.

In addition to one or more of the features described herein, the response is an edit of the personalized speed, and the processor sets the new cruise speed to be a result of the edit of the personalized speed.

In addition to one or more of the features described herein, the response is a non-responsive period for a specified duration, and the processor maintains the cruise speed for the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that implements cruise control and provides a cruise speed suggestion based on traffic flow according to one or more embodiments;

FIG. 2 is a process flow of a method of providing a cruise speed suggestion based on traffic flow according to one or more embodiments; and

FIG. 3 is an illustration of controlling cruise speed based on traffic flow according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Setting a cruise speed manually or automatically without information of the traffic can lead to non-optimal speed values of different vehicles riding on the same road since these are uncoordinated. When a given lead vehicle travelling at a given speed in a lane brakes, and if the lane is saturated such that the distances between adjacent vehicles are relatively small, a traffic wave can be propagated downstream. This traffic wave refers to every driver behind the lead vehicle continuing at the given speed until braking is required. This behavior of maintaining speed until hard braking is required may exacerbate a traffic jam and generally slow the flow of traffic. However, if a following vehicle slowed based on knowledge that the lead vehicle or another vehicle that is several vehicles ahead of the following vehicle had braked, then this slowing behavior of the following vehicle may dissipate the traffic wave that travels from the braking vehicle to the following vehicle. Thus, this slowing behavior of the following vehicle will improve traffic flow. Embodiments of the systems and methods detailed herein relate to a cruise speed suggestion based on traffic flow. Communication (e.g., vehicle-to-vehicle (V2V) communication) is used to identify braking by a vehicle that may be several vehicles ahead. The communication may identify a change in the vehicle spacing ahead (even in the absence of hard braking). The communication may facilitate deducing that the lane has become saturated and the chance of the emergence of a traffic wave is increased. An optimal cruise speed, which may involve slowing even though the vehicle immediately in front is maintaining speed, is computed in consideration of traffic flow. Rather than implementing this optimal cruise speed, a vehicle user (e.g., driver in a semi-autonomous vehicle, passenger in an autonomous vehicle) is presented with a personalized speed that is derived from past behavior in accepting the suggestion of the optimal cruise speed.

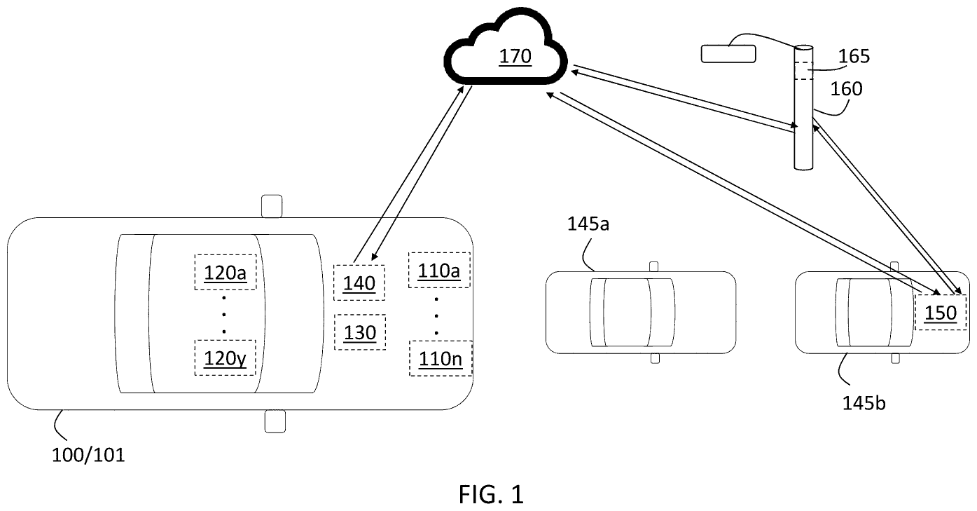

In accordance with an exemplary embodiment, FIG. 1 is a block diagram of a vehicle 100 that implements cruise control and provides a personalized cruise speed suggestion to improve traffic flow. The exemplary vehicle 100 is an automobile 101. The vehicle 100 may include one or more sensors 110a through 110n (generally referred to as 110). Exemplary sensors 110 may include a radar system, a lidar system, and a camera. Typically, these sensors 110 detect objects that are in the field of view of the sensor 110. The vehicle 100 is also shown to have one or more interfaces 120a through 120y (generally referred to as 120) with the user. An exemplary interface 120 may include a dashboard display with buttons on the steering wheel or a touchscreen of the display to obtain user input. Another exemplary interface 120 includes an audio or speech interface or mobile interface.

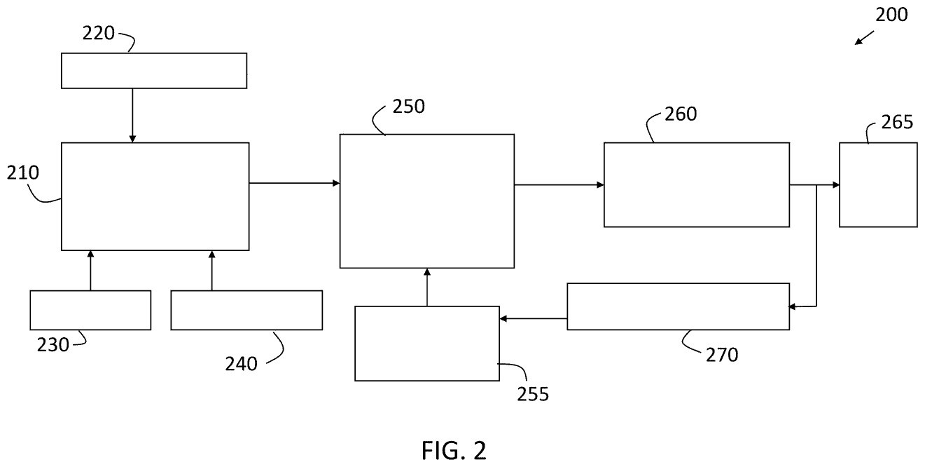

The vehicle 100 also includes a controller 130. The controller 130 may be one or a set of components that communicate with each other to perform the functionality described herein. The controller 130 is used to calculate the optimal cruise speed, determine a personalized speed, and control interactions with the user, as detailed with reference to FIG. 2. The controller 130 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The vehicle 100 also includes a communication device 140. The communication device 140 may include a receiver and a transmitter to facilitate communication outside the vehicle 100. The communication device 140 may interface with a remote communication device 170, which may be a cloud-based service or another service that facilitates receiving information, processing information, and transmitting information via wireless communication.

Two other exemplary vehicles 145a and 145b are shown in FIG. 1. The vehicle 145a is in the line of sight of vehicle 100 and, thus, can be monitored and sensed by sensors 110. The other vehicle 145b may be occluded by vehicle 145a and, therefore, cannot be monitored and sensed by sensors 110. This vehicle 145b may have a communication device 150 which enables receiving and transmitting information outside the vehicle 145b. An infrastructure 160 (e.g., light pole, traffic light, road sign, road side unit) may also be equipped with a communication unit 165, for receiving and transmitting information. The communication device 140 inside vehicle 100 performs V2V communication with the communication device 150 in vehicle 145b. The communication device 140 inside vehicle 100 may additionally perform vehicle-to-infrastructure (V2I) or vehicle-to-everything (V2X) communication with the communication device 165 in infrastructure 160 and with cloud 170. For example, vehicle 145b may broadcast its speed, position (GPS data), heading, lane, acceleration, distance to preceding vehicle, brake position to cloud 170. Infrastructure 160 may broadcast traffic information via communication device 165 to cloud 170. The traffic information can include a measured number of cars at a specific location, a creation of a jam, and a measured number of braking events of the vehicles communicating with infrastructure 160.

Vehicle 145b may communicate directly, using the communication device 150, with the communication device 165 in infrastructure 160. This type of communication can include vehicle 145b speed, position (GPS data), heading, lane, acceleration, distance to preceding vehicle, and brake position. Cloud 170 may have a processing unit that performs data manipulation. For example, cloud 170 may receive information for vehicles traveling on other roads near vehicle 100 but not in the same direction, therefore, cloud 170 may sort the data and may transmit the relevant data to vehicle 100 based on its current (time dependent) GPS position. The processing circuitry unit in cloud 170 may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 is a process flow of a method 200 of providing a personalized cruise speed suggestion to improve traffic flow according to one or more embodiments. For explanatory purposes, the vehicle 100 that obtains the personalized cruise speed suggestion based on traffic flow, according to one or more embodiments, is referred to as the ego vehicle 100 and the other vehicles 145a, 145b in front of the ego vehicle 100 in the same lane or other lanes are referred to as preceding vehicles 145. At block 210, computing an optimal speed may be performed as an event-based process (e.g., a braking event is detected among preceding vehicles 145) but may also, alternately or additionally, be performed on a periodic basis. The computation, at block 210, may involve several inputs. The cruise speed, at block 220, refers to the cruise speed selected by the driver of the ego vehicle 100 in a semi-autonomous scenario. In an autonomous ego vehicle 100, the cruise speed may be based on a stored profile of a passenger or other automated decisions made by the agent controlling the autonomous vehicle. For example, a passenger may select a mode (e.g., sport mode, comfort mode) that determines a desired cruise speed in a given scenario (e.g., highway, heavy traffic). As another example, an automated decision-making agent may determine the cruise speed.

Sensor data, at block 230, may be from one or more sensors 110 (e.g., radar system, lidar system, camera). As previously noted, the sensor data provides information about objects (e.g., vehicle 145a, infrastructure 160 in FIG. 1). The radar system and lidar system facilitate not only the detection of an object but also a position of that object relative to the ego vehicle 100. Communication, at block 240, facilitates obtaining information about preceding vehicles 145. Communication 240 may be based on using the communication device 140 in FIG. 1. As previously noted, this communication may include both V2V and V2I or V2X communication. The information obtained in the communication may indicate a braking event, for example, or information about the distances or a change in the distance between adjacent preceding vehicles 145. In addition, the locations of the communicating preceding vehicles 145 may be indicated.

Based on the inputs, the controller 130 of the ego vehicle 100 may determine the locations and speeds of the preceding vehicles 145 and additional information such as the percentage of preceding vehicles 145 that have V2V communication capability, for example. The computation of optimal speed, at block 210, may be determined in different ways according to alternate embodiments. According to an exemplary embodiment, the optimal speed may be computed as an average speed of other vehicles 145 (both preceding vehicles 145 and following vehicles 145) within a specified distance of the ego vehicle 100. According to another exemplary embodiment, the optimal speed may be computed as a weighted average of speeds of other vehicles 145 within a specified distance. The weighting may correspond with the distance of a given other vehicle 145 to the ego vehicle 100. For example, the speed of other vehicles 145 that are closer to the ego vehicle 100 may be weighted more than the speed of other vehicles 145 that are farther from the ego vehicle 100 within the specified distance. According to yet another exemplary embodiment, the optimal speed may be computed based on an acceleration. An acceleration or deceleration needed to achieve a desired speed over a specified time (e.g., five seconds) may be determined. The optimal speed may be derived from this acceleration or deceleration. The optimal speed may also be computed according to a combination of parameters, such as: i) prior relationship between the current ego vehicle speed and its distance to the preceding vehicle 145, ii) the time derivative of the distance of the ego vehicle to its preceding vehicle 145, iii) the average speed or weighted average speed of the vehicles ahead.

At block 250, determining a personalized speed initially or for a new user may simply involve using the optimal speed (computed at block 210) as the personalized speed. A user behavior model, at block 255, provides input to the determination of personalized speed, at block 250. Additional information that may be used to determine the personalized speed, at block 250, includes the current state of the ego vehicle 100. The current state may refer to a speed range. For example, states may be defined as slow speed=0 to 30 miles per hour (mph), medium speed=31 to 50 mph, fast speed=51 to 70 mph. Additional and alternate states may be defined, as well, to include more or fewer ranges and different speed values for those ranges. The user model, at block 255, provides information about a user's past behavior. For example, the personalized speed may be determined using a probabilistic model or machine learning method as the user behavior model, at block 255.

If the probabilistic model indicates that the probability that the user will accept the optimal speed (computed at block 210), given the current state of the ego vehicle 100, if over a threshold value (e.g., 70 percent), then the personalized speed may be set (at block 250) to the optimal speed. If the probability that the user will edit the optimal speed computed, at block 210, is over a threshold value, then the proposed personalized speed is selected to maximize the likelihood of being the result of the user edit action. If the probabilistic model indicates that the probability that the user will ignore (i.e., neither accept nor modify) the optimal speed is greater than a threshold value, then the personalized speed remains as the original cruise speed at block 220. For example, if the current cruise speed is the speed limit (e.g., 65 miles per hour) and the optimal speed is computed (at block 210) as 35 miles per hour, then the personalized speed may be modified to a value less than the cruise speed but within the same speed category (e.g., slow speed, medium speed, normal speed, fast speed, very fast speed) rather than as slow as the optimal speed (e.g., 35 miles per hour).

Presenting the personalized speed to the user and obtaining a response, at block 260, may use one or more of the interfaces 120. The user may accept the personalized speed, edit the personalized speed, or ignore the personalized speed. If the user accepts the personalized speed or edits the personalized speed to generate an edited personalized speed, then setting the speed, at block 265, means setting the new cruise speed to be the personalized speed (in the case of acceptance) or the edited personalized speed (in the case of an edit). If the user ignores the request regarding a personalized speed (presented at block 260) for a specified period of time (e.g., 30 seconds), then the cruise speed (at input 220) may be maintained (at block 265) without any change. That is, following a specified duration of a non-responsive period, the cruise speed remains the speed at block 265. Additionally, the method 200 may be repeated after a specified duration (e.g., five minutes). Regardless of the user response to the presentation (at block 260), feeding back the user decision (e.g., accept, edit, ignore), at block 270, facilitates updating the user behavior model (e.g., probabilistic model), at block 255, that is used to determine the personalized speed, at block 250, subsequently.

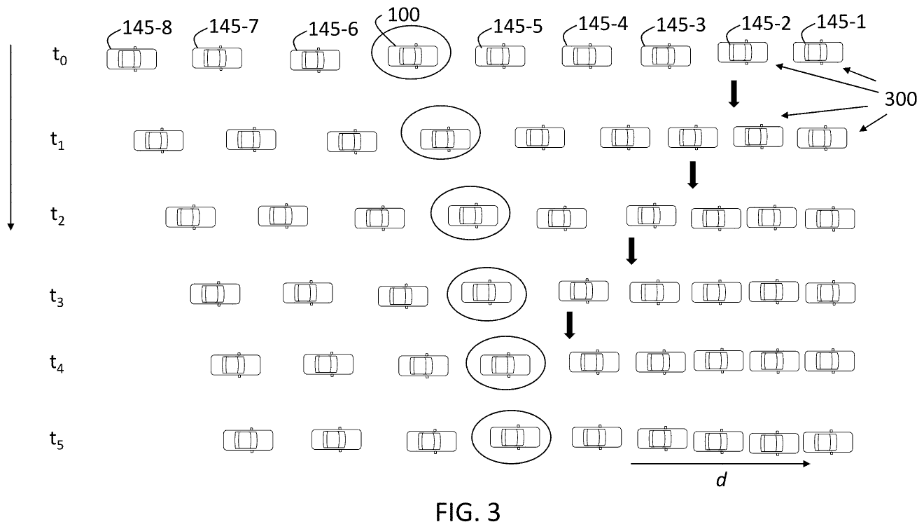

FIG. 3 is an illustration of controlling cruise speed based on traffic flow according to one or more embodiments. The relative position of nine cars 300 is shown for six different time instances from to through t₅. The direction of travel d is also indicated, and all the cars 300 can be assumed to be travelling at the same speed at initial time instance to. The ego vehicle 100 is circled. There are five preceding vehicles 145-1 through 145-5 and three following vehicles 145-6 through 145-8. Because the order of the nine cars 300 does not change, they are not relabeled at each time instance. As FIG. 3 indicates, preceding vehicle 145-2 brakes at time instance t₁. This results in preceding vehicle 145-3 braking at time instance t₂, preceding vehicle 145-4 braking at time instance t₃, and preceding vehicle 145-5 braking at time instance t₄. Preceding vehicles 145-1 through 145-5 illustrate the traffic wave that can be curtailed based on a cruise speed based on traffic flow, according to one or more embodiments.

A view of preceding vehicle 145-2 is obscured (i.e., blocked by preceding vehicles 145-3, 145-4, and 145-5) for any field-of-view sensors 110 (FIG. 1) of the ego vehicle 100. But, the ego vehicle 100 may learn of the braking event at preceding vehicle 145-2 based on V2V or V2I or V2X communication, for example. Processes according to the method 200 shown in FIG. 2 are used in the ego vehicle 100 to set a speed, at block 265, which is slower than the initial cruise speed (at block 220). Thus, as shown, by time instance t₂, the ego vehicle 100 slows. As a result, by time instance t₅, at which ego vehicle 100 would have to brake if the traffic wave had been allowed to propagate, the ego vehicle 100 may instead proceed at the slower speed without braking. Because the ego vehicle 100 does not have to brake, any following vehicles 145-6, 145-7, 145-8, regardless of whether they include the ability to adjust cruise speed according to one or more embodiments, may avoid the traffic wave. Overall traffic flow is improved by even one ego vehicle 100 implementing the traffic flow-based cruise speed, according to one or more embodiments.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method, comprising:
obtaining, using a processor, a cruise speed for a vehicle;
computing, using the processor, an optimal speed for the vehicle in consideration of traffic flow, the computing the optimal speed being based on the cruise speed and additional information;
determining, using the processor, a personalized speed for the vehicle based on a model corresponding with a current user of the vehicle;
suggesting the personalized speed to the current user for a response; and
setting a new cruise speed for the vehicle according to the response of the current user, wherein the vehicle is controlled to travel at the new cruise speed.

2. The method according to claim 1, wherein the obtaining the cruise speed includes obtaining a cruise control speed setting by the current user who is a driver or using a user profile corresponding with the current user.

3. The method according to claim 1, wherein the computing the optimal speed includes determining an average speed of every other vehicle within a specified distance of the vehicle or determining a weighted average speed with weighting being higher or lower for closer other vehicles.

4. The method according to claim 1, wherein the computing the optimal speed includes determining an acceleration or deceleration required to achieve a specified speed over a specified duration.

5. The method according to claim 1, wherein the determining the personalized speed includes using a probabilistic model based on past responses by the current user or a machine learning algorithm to predict the personalized speed that maximizes acceptance by the current user.

6. The method according to claim 1, further comprising obtaining the additional information from one or more sensors, the one or more sensors including at least a radar system, a lidar system, or a camera.

7. The method according to claim 1, further comprising obtaining the additional information from another vehicle based on vehicle-to-vehicle communication.

8. The method according to claim 7, wherein the obtaining the additional information from the other vehicles includes obtaining an indication that one or more vehicles ahead of the vehicle braked, or that a distance between the other vehicles ahead of the vehicle has decreased to a threshold distance.

9. The method according to claim 1, further comprising obtaining the response from the current user, wherein the response is a confirmation and the setting the new cruise speed includes setting the new cruise speed to be the personalized speed, or the response is an edit of the personalized speed, wherein the setting the new cruise speed includes setting the new cruise speed to be a result of the edit of the personalized speed.

10. The method according to claim 1, further comprising obtaining the response as a non-responsive period for a specified duration, wherein the setting the new cruise speed includes setting the new cruise speed to remain the cruise speed.

11. A system, comprising:
one or more sensors, wherein the one or more sensors includes a radar system, a lidar system, or a camera; and
a processor configured to obtain a cruise speed for a vehicle, to compute an optimal speed for the vehicle in consideration of traffic flow based on the cruise speed, information from the one or more sensors, and additional information, to determine a personalized speed for the vehicle based on a model corresponding with a current user of the vehicle, to suggest the personalized speed to the current user for a response, and to set a new cruise speed for the vehicle according to the response of the current user, wherein the vehicle is controlled to travel at the new cruise speed.

12. The system according to claim 11, wherein the cruise speed is a cruise control speed setting by the current user who is a driver, a speed determined from a user profile corresponding with the current user, or from an automated decision making agent controlling a speed of an autonomous vehicle.

13. The system according to claim 11, wherein the processor is configured to compute the optimal speed by determining an average speed of every other vehicle within a specified distance of the vehicle or determining a weighted average speed with weighting being higher or lower for closer other vehicles.

14. The system according to claim 11, wherein the processor is configured to compute the optimal speed based on an acceleration or deceleration required to achieve a specified speed over a specified duration.

15. The system according to claim 11, wherein the processor is configured to determine the personalized speed by using a probabilistic model based on past responses by the current user or a machine learning algorithm that learns to predict the personalized speed that maximizes acceptance by the current user.

16. The system according to claim 11, wherein the additional information is communicated from another vehicle based on vehicle-to-vehicle communication.

17. The system according to claim 16, wherein the additional information from the other vehicles includes an indication that one or more vehicles ahead of the vehicle braked, or that the distance between the vehicles ahead has decreased to a certain threshold distance.

18. The system according to claim 11, wherein the response is a confirmation and the processor is configured to set the new cruise speed to be the personalized speed.

19. The system according to claim 11, wherein the response is an edit of the personalized speed, and the processor is configured to set the new cruise speed to be a result of the edit of the personalized speed.

20. The system according to claim 11, wherein the response is a non-responsive period for a specified duration, and the processor is configured to maintain the cruise speed for the vehicle.
